(19) United States
(12) Patent Application Publication
(10) Pub. No.: US 2020/0116510 A1
(43) Pub. Date: Apr. 16, 2020

(54) RIDE-SHARING PARTNER MATCHING METHOD AND RIDE-SHARING PARTNER MATCHING SYSTEM

(71) Applicant: TOYOTA JIDOSHA KABUSHIKI KAISHA, Toyota-shi (JP)

(72) Inventor: Takashige HORI, Aisai-shi (JP)

(73) Assignee: TOYOTA JIDOSHA KABUSHIKI KAISHA, Toyota-shi (JP)

(21) Appl. No.: 16/545,510

(22) Filed: Aug. 20, 2019

(30) Foreign Application Priority Data
Oct. 12, 2018 (JP) 2018-193402

(51) Int. Cl. G01C 21/34; G06K 9/62

(52) U.S. Cl. CPC G01C 21/3438; G01C 21/3484; G06K 9/6201

(57) ABSTRACT

When there is the second user who is already in a vehicle or is going to ride in the vehicle earlier and when the profile information of the first user satisfies the matching requirement for the second user set by the second user, the matching unit determines that the first user can ride with the second user. The matching requirement of the second user can be changed upon input from the second user or according to the riding and alighting positions of the second user.

A general purpose of the present disclosure is to provide a technology with which a user who rides earlier can ride with another user according to the user's preference.

In response to the above issue, a ride-sharing partner matching method of one embodiment of the present disclosure includes: acquiring position information of a vehicle used in a sharing service; acquiring riding and alighting positions of a first user; extracting, based on the position information of a vehicle and the riding and alighting positions of the first user, a combination of a vehicle and the first user; acquiring, when there is a second user who is already in a vehicle or is going to ride in the vehicle earlier, profile information of the first user and a matching requirement for ride-sharing partners set by the second user; and determining that, when the profile information of the first user satisfies the matching requirement of the second user, the first user can ride with the second user. The matching requirement of the second user can be changed upon input from the second user or according to the riding and alighting positions of the second user.

According to this embodiment, in the matching between passengers who ride together in a vehicle, a passenger, who rides earlier, can ride with a user who satisfies a set requirement. Also, since the matching requirement of a user can be changed, when the user is in a hurry or wishes for a short-distance ride, the matching requirement can be eased to facilitate ride-sharing.

Another embodiment of the present disclosure relates to a ride-sharing partner matching system. The ride-sharing partner matching system includes: a position acquirer configured to acquire position information of a vehicle used in a sharing service; a user information retaining unit configured to retain profile information of each of a first user and a second user; a requirement management unit configured to retain a matching requirement for another user as a ride-sharing partner, set by the second user; and a matching unit configured to extract, based on the position information of a vehicle and acquired riding and alighting positions of the first user, a combination of the vehicle and the first user. When there is the second user who is already in the vehicle or is going to ride in the vehicle earlier and when the profile information of the first user satisfies the matching requirement for the second user set by the second user, the matching unit determines that the first user can ride with the second user. The matching requirement of the second user can be changed upon input from the second user or according to the riding and alighting positions of the second user.

### BRIEF DESCRIPTION OF THE DRAWINGS

Embodiments will now be described, by way of example only, with reference to the accompanying drawings that are meant to be exemplary, not limiting, and wherein like elements are numbered alike in several figures, in which:

FIG. 1 is a diagram that shows an overview of a ride-sharing partner matching system according to an embodiment;

FIG. 2 is a diagram used to describe a situation where a first user and a second user ride together in a vehicle;

FIG. 3 is a diagram used to describe a functional configuration of a server device; and

FIGS. 4A-4C are diagrams used to describe a screen displayed on a first mobile terminal when the first user uses a ride-sharing service.

### DETAILED DESCRIPTION

An embodiment will now be described. The embodiment is illustrative and is not intended to be limiting.

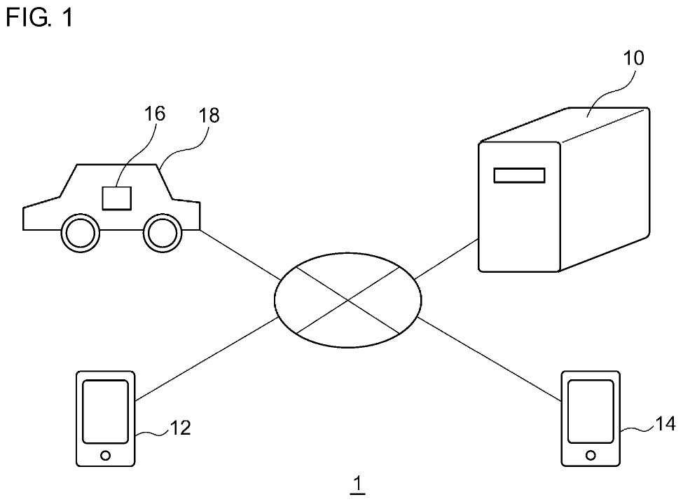

FIG. 1 is a diagram that shows an overview of a ride-sharing partner matching system 1 according to an embodiment. The ride-sharing partner matching system 1 provides a ride-sharing service for supporting ride-sharing of a vehicle. The ride-sharing partner matching system 1 includes a server device 10, a first mobile terminal 12, a second mobile terminal 14, and a vehicle-mounted terminal 16, which are connected to one another via a network.

The server device 10 guides a first user, who has the first mobile terminal 12, and a second user, who has the second mobile terminal 14, into a vehicle 18, and mediates between each user and the vehicle 18. Although FIG. 1 shows two mobile terminals and one vehicle-mounted terminal 16, the ride-sharing partner matching system is actually implemented by three or more mobile terminals and two or more vehicle-mounted terminals.

The vehicle-mounted terminal 16 is mounted on the vehicle 18 and transmits position information of the vehicle to the server device 10. The vehicle-mounted terminal 16 may also transmits, to the server device 10, a traveling route of the vehicle 18, and a scheduled departure time and a scheduled arrival time on the traveling route. Also, the driver of the vehicle 18 may transmit the traveling route and the position information to the server device 10 using a mobile terminal, instead of the vehicle-mounted terminal 16.

The driver of the vehicle 18 transmits information of the vehicle 18 from the vehicle-mounted terminal 16 to the server device 10 to register the vehicle 18. The information of the vehicle 18 includes the type and the rank of the vehicle, how new the vehicle is, the seating capacity, and equipment information regarding whether or not a child safety seat is provided or regarding a ski carrier, studless tires, and the like. Also, profile information of the driver may be included in attribute information of the vehicle 18. The attribute information of the vehicle 18 is used when a user determines whether or not to ride the vehicle 18. The driver information is related to a driver ID of the driver and to a terminal ID.

Each of the first mobile terminal 12 and the second mobile terminal 14 holds an application program used for the ride-sharing service, transmits information entered by a user to the server device 10, and receives information regarding ride-sharing from the server device 10. When use of the service is started, each of the first mobile terminal 12 and the second mobile terminal 14 transmits the profile information of the user to the server device 10, so that the user is registered. The profile information of the user includes the gender, age, whether or not the user smokes, hobby and preference information, and whether or not the user allows talking during ride-sharing, for example. The profile information of the first user is related to the user ID of the first user and the terminal ID of the first mobile terminal 12, and the profile information of the second user is related to the user ID of the second user and the terminal ID of the second mobile terminal 14.

When the first user uses the ride-sharing service, the first user enters riding and alighting positions and a scheduled riding time into the first mobile terminal 12, and the entered information is transmitted from the first mobile terminal 12 to the server device 10. Similar processing is also performed on the second mobile terminal 14.

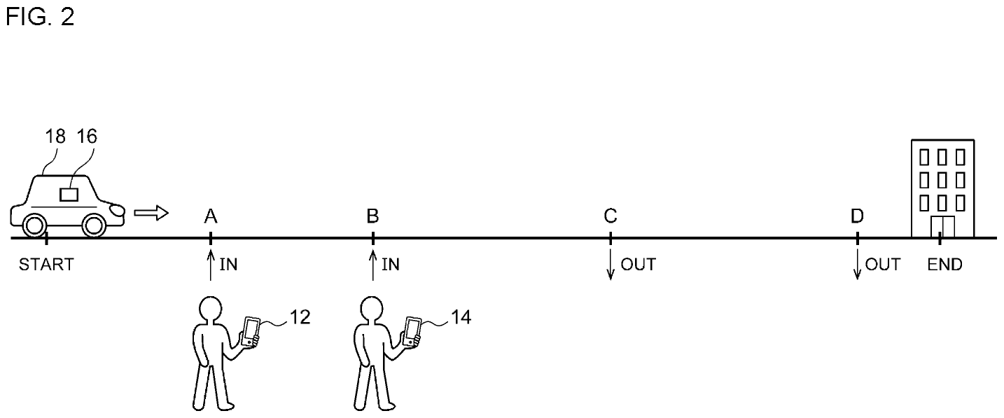

FIG. 2 is a diagram used to describe a situation where the first user and the second user ride together in the vehicle 18. To use the ride-sharing service, the driver of the vehicle 18 sends, to the server device 10, information indicating acceptance of users' riding, current position information as a starting point, and destination information, and then departs from the starting point. Meanwhile, the first user and the second user are to use the ride-sharing service to travel by vehicle.

The first user enters a riding point A and an alighting point C into the first mobile terminal 12, which then transmits the entered information to the server device 10. Based on the riding point A and alighting point C of the first user and position information of each vehicle, the server device 10 extracts a vehicle available for the first user. For example, the server device 10 extracts vehicles in order of proximity to the riding point A. The server device 10 then transmits the information of each vehicle thus extracted to the first mobile terminal 12.

The first mobile terminal 12 acquires the information of each vehicle from the server device 10 and displays a list of vehicles available for the first user. When the first user inputs an operation for selecting the vehicle 18 to the first mobile terminal 12, the first mobile terminal 12 transmits, to the server device 10, information indicating that the vehicle 18 has been selected. The first mobile terminal 12 also transmits to the server device 10 a matching requirement for ride-sharing partners set by the first user.

The server device 10 transmits, to the vehicle-mounted terminal 16, a query as to whether or not the first user can ride, and the vehicle-mounted terminal 16 transmits, to the server device 10 in reply, information indicating that the driver has accepted the ride. Accordingly, the driver drives the vehicle 18 to the point A and picks up the first user.

The second user enters a riding point B and an alighting point D into the second mobile terminal 14, which then transmits the entered information to the server device 10. Based on the riding point B and alighting point D of the second user and position information of each vehicle, the server device 10 extracts a vehicle available for the second user. Also, the server device 10 refers to the profile information of the second user to judge if the second user satisfies the matching requirement set by the first user, and, when the second user satisfies the matching requirement, the server device 10 also extracts the vehicle 18. The server device 10 then transmits the information of each vehicle thus extracted to the second mobile terminal 14.

The second mobile terminal 14 acquires the information of each vehicle from the server device 10 and displays a list of vehicles available for the second user. When the second user inputs an operation for selecting the vehicle 18 to the second mobile terminal 14, the second mobile terminal 14 transmits, to the server device 10, information indicating that the vehicle 18 has been selected. The second mobile terminal 14 also transmits to the server device 10 a matching requirement for ride-sharing partners set by the second user.

The server device 10 transmits, to the vehicle-mounted terminal 16, a query as to whether or not the second user can ride, and the vehicle-mounted terminal 16 transmits, to the server device 10 in reply, information indicating that the driver has accepted the ride. Accordingly, the driver drives the vehicle 18 to the point B and picks up the second user. In this way, the first user sets a first matching requirement and rides in the vehicle 18 first, and the second user, who satisfies the first matching requirement, then rides in the vehicle 18, so that the first user can comfortably ride with a desired partner and can use the vehicle at a less expensive fee by ride-sharing.

When the vehicle 18 arrives at the alighting point C of the first user and the first user alights, the matching requirement set by the first user is removed, and only the matching requirement set by the second user is maintained. In order for another user to ride with the second user in the vehicle 18, the another user needs to satisfy the matching requirement set by the second user.

When the vehicle 18 arrives at the alighting point D of the second user and the second user alights, the matching requirement set by the second user is removed. In this way, the first user and the second user can ride together in the vehicle 18. Although FIG. 2 shows a situation where the first user and the second user decide ride-sharing in the vehicle 18 that was moving at the time, the situation is not limited thereto, and the users may decide ride-sharing using an advance reservation.

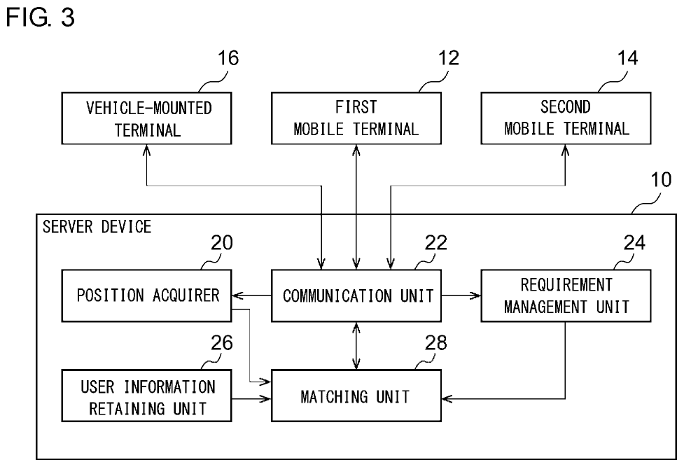

FIG. 3 is a diagram used to describe a functional configuration of the server device 10. Each of the elements represented by functional blocks for performing various processes shown in FIG. 3 can be implemented by a circuit block, a memory, an LSI or the like in terms of hardware, and by a program loaded into a memory or the like in terms of software. Accordingly, it will be obvious to those skilled in the art that these functional blocks may be implemented in a variety of forms by hardware only, software only, or a combination thereof, and the form is not limited to any of them.

The server device 10 includes a position acquirer 20, a communication unit 22, a requirement management unit 24, a user information retaining unit 26, and a matching unit 28. The communication unit 22 transmits and receives information to and from the first mobile terminal 12, the second mobile terminal 14, and the vehicle-mounted terminal 16, via a network.

The position acquirer 20 acquires position information of each of multiple vehicles using the ride-sharing service, and acquires, from the vehicle-mounted terminal 16, route information in addition to the position information of the vehicle 18. To the position information of a vehicle, time information of the time at which the position information is acquired is attached. The route information of the vehicle 18 is route guidance information generated based on the destination set in a navigation device, for example, and indicates a route connecting a departure point, which is the current position of the vehicle 18, and an arrival point, which is the set destination. The position acquirer 20 may acquire the position information of the vehicle 18 and the destination information of the vehicle 18.

The user information retaining unit 26 retains, as user information, profile information and a user ID. The profile information is entered into a mobile terminal at the time of user registration and includes the gender, age, whether or not the user smokes, hobby and preference information, and whether or not the user allows talking during ride-sharing, for example. The user information includes driver's information and passenger's information. The driver's user information may include vehicle information of a vehicle used for ride-sharing, in addition to the profile information of the driver. The vehicle information includes the type and the rank of the vehicle, how new the vehicle is, the seating capacity, and equipment information, for example.

The profile information of a user may also include an evaluation degree determined by a ride-sharing partner who has ridden with the user. The evaluation degree is determined by other users who each have ridden with the user in the same vehicle, and is an index indicating the degree of comfortable riding with the user.

The requirement management unit 24 retains a matching requirement for ride-sharing partners set by a user, related to the user ID. The matching requirement limits a ride-sharing partner who joins in ride-sharing later, and whether or not the matching requirement is satisfied is judged based mainly on the profile information of the user. For example, in the matching requirement, a gender, age, whether or not smoking is allowed, the maximum number of passengers, and whether or not talking during ride-sharing is allowed may be set. When a user decides to ride, the requirement management unit 24 applies the matching requirement set by the user, and, when the user alights, the requirement management unit 24 removes the matching requirement. In the matching requirement, the evaluation degree of the user being a predetermined value or greater may also be set.

Based on the position information of each of multiple vehicles and the riding and alighting positions of users, the matching unit 28 extracts a combination of a vehicle and a user. The matching unit 28 may also extract a combination of a vehicle and a user based on the route information of each of multiple vehicles and the riding and alighting positions of users, and may also extract a combination of a vehicle and a user based on the position information and the destination of each of multiple vehicles and the riding and alighting positions of users. For example, the matching unit 28 may extract vehicles in order of proximity to the riding point of a passenger.

In ride-sharing, when there is the first user who is already in a vehicle or is going to ride in the vehicle earlier, the matching unit 28 judges if the second user satisfies the matching requirement for ride-sharing partners set by the first user. When there is the first user who rides earlier, the matching unit 28 acquires the profile information of the second user and the matching requirement set by the first user, and, when the profile information of the second user satisfies the matching requirement set by the first user, the matching unit 28 determines ride-sharing of the first user and the second user. Accordingly, the first user, who rides earlier, can ride with a partner who satisfies the requirement set by the first user. For example, a female user can ride only with females.

The second user, who rides later, may also set a matching requirement. The matching requirement for ride-sharing partners set by the second user may be a requirement for the first user who is already in a vehicle, or may be a requirement for a third user who rides further later. Accordingly, each user can ride with a partner who satisfies the requirement set by the user.

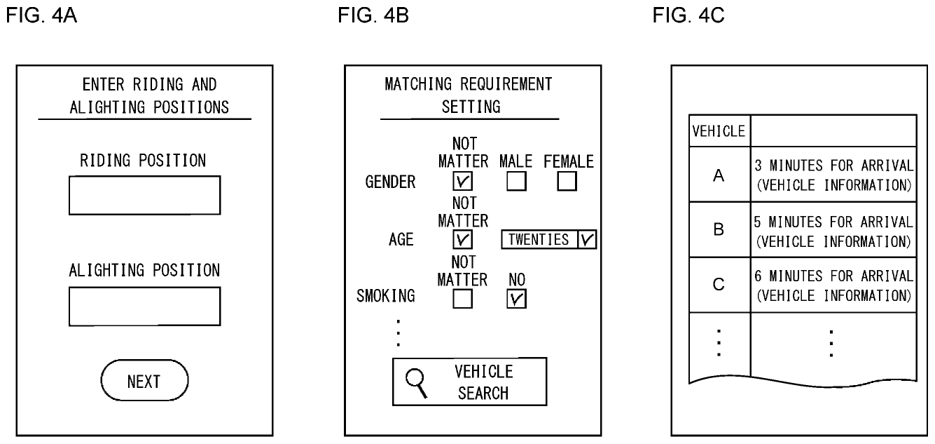

FIG. 4 are diagrams used to describe a screen displayed on the first mobile terminal 12 when the first user uses the ride-sharing service. After the user logs in, the first mobile terminal 12 displays an image on which riding and alighting positions are entered, as shown in FIG. 4A. Accordingly, the first user enters riding and alighting positions into the riding position entry field and the alighting position entry field, and performs a touch operation on the “NEXT” button to complete the entry of riding and alighting positions. In the riding position entry field and the alighting position entry field shown in FIG. 4A, a scheduled riding time and a scheduled alighting time may also be respectively set. Upon the touch operation on “NEXT”, the first mobile terminal 12 transmits the entered riding and alighting positions to the server device 10, and shifts the screen to a screen for matching requirement setting.

As shown in FIG. 4B, the first mobile terminal 12 displays an imaged on which the matching requirement is set. In FIG. 4B, the checkbox of “NO” for smoking of ride-sharing partners is checked off, which means smoking is not allowed, and the other items are set to “NOT MATTER”.

The first mobile terminal 12 displays the screen in which check marks are placed to coincide with the matching requirement set in advance by the first user. With a touch operation on another checkbox with no check mark, the another checkbox is checked off, so that the first user can change the matching requirement for each ride.

When the user sets the matching requirement and performs a touch operation on the “VEHICLE SEARCH” button, the first mobile terminal 12 transmits an instruction signal for ordering the start of search to the server device 10. Based on the position information of each of multiple vehicles and the riding and alighting positions of the first user, the matching unit 28 of the server device 10 extracts a combination of a vehicle and the first user, and the communication unit 22 transmits the extraction result to the first mobile terminal 12.

As shown in FIG. 4C, the first mobile terminal 12 displays a list of vehicles extracted by the matching unit 28, in order of proximity to the riding position of the first user. In FIG. 4C, each extracted vehicle is displayed with a time required until the vehicle arrives at the riding position of the first user, and the vehicle information.

Based on the displayed information, the first user selects a desired vehicle with touch operation, and the first mobile terminal 12 transmits the selection result of the first user to the server device 10. Upon reception of the vehicle selection result from the first mobile terminal 12, the server device 10 transmits the riding and alighting positions of the first user to the vehicle-mounted terminal on the vehicle, and also notifies the driver of information indicating that the first user is going to ride in the vehicle. In the server device 10, the requirement management unit 24 retains the matching requirement set by the first user, and the matching unit 28 does not allow a passenger to ride with the first user unless the passenger satisfies the matching requirement set by the first user.

The matching requirement of the first user may be automatically changed based on the riding and alighting positions of the first user. For example, when the travel distance of the first user obtained based on the riding and alighting positions of the first user is a predetermined value or less, the matching unit 28 may ease the matching requirement of the first user. Also, for example, when the travel distance of the first user is remarkably short, the matching unit 28 may ease the matching requirement and set no limitation on ride-sharing partners. This can restrain the second user, who joins in the ride-sharing later, from hesitating to ride because of the short travel distance of the first user. Easing the matching requirement means removing at least one of multiple limitation items included in the matching requirement.

The matching requirement of the first user may be one of a general matching requirement and a special matching requirement eased from the general matching requirement. When the travel distance of the first user is longer than a predetermined value, the matching unit 28 selects the general matching requirement, and, when the travel distance of the first user is the predetermined value or less, the matching unit 28 selects the special matching requirement. This can restrain the second user, who joins in the ride-sharing later, from hesitating to ride because of the short travel distance of the first user.

Also, the matching requirement of the first user may be automatically changed based on the riding and alighting positions of the second user who rides later. For example, when the travel distance of the second user, who rides later, is a predetermined value or less, the matching unit 28 may ease the matching requirement of the first user and set no limitation on ride-sharing partners. This enables a user who is to ride for a short travel distance to casually join in ride-sharing.

Each of the first user and the second user pays a fee after a ride using the ride-sharing service. The fee may be determined based on the number of limitations set in the matching requirement. For example, the fee for a user who has set a relatively large number of limitations in the matching requirement may be higher than the fee for a user who has set a relatively small number of limitations. In the ride-sharing service, when a larger number of passengers ride together, the fees therefor become less expensive; however, if the limitations in the matching requirement are increased, ride-sharing will be difficult, so that the fee for a person who makes the ride-sharing more difficult may be set higher.

The embodiment is intended to be illustrative only, and it will be obvious to those skilled in the art that various modifications to a combination of constituting elements could be developed and that such modifications also fall within the scope of the present disclosure.

1. A ride-sharing partner matching method, comprising:
acquiring position information of a vehicle used in a sharing service;
acquiring riding and alighting positions of a first user;
extracting, on the basis of the position information of a vehicle and the riding and alighting positions of the first user, a combination of a vehicle and the first user;
acquiring, when there is a second user who is already in a vehicle or is going to ride in the vehicle earlier, profile information of the first user and a matching requirement for ride-sharing partners set by the second user; and
determining that, when the profile information of the first user satisfies the matching requirement of the second user, the first user can ride with the second user,
wherein the matching requirement of the second user can be changed upon input from the second user or according to the riding and alighting positions of the second user.

2. The ride-sharing partner matching method of claim 1, wherein, in the determining, when the profile information of the first user satisfies the matching requirement of the second user and also when the profile information of the second user satisfies a matching requirement set by the first user, it is determined that the first user can ride with the second user.

3. The ride-sharing partner matching method of claim 1, further comprising determining that, when a third user rides after the first user and the second user and when the profile information of the third user satisfies the matching requirement set by the first user and the matching requirement set by the second user, the third user can ride with the first user and the second user.

4. A ride-sharing partner matching system, comprising:
a position acquirer configured to acquire position information of a vehicle used in a sharing service;
a user information retaining unit configured to retain profile information of each of a first user and a second user;
a requirement management unit configured to retain a matching requirement for another user as a ride-sharing partner, set by the second user; and
a matching unit configured to extract, on the basis of the position information of a vehicle and acquired riding and alighting positions of the first user, a combination of the vehicle and the first user, wherein:
when there is the second user who is already in the vehicle or is going to ride in the vehicle earlier and when the profile information of the first user satisfies the matching requirement for the second user set by the second user, the matching unit determines that the first user can ride with the second user; and
the matching requirement of the second user can be changed upon input from the second user or according to the riding and alighting positions of the second user.

5. The ride-sharing partner matching method of claim 2, further comprising determining that, when a third user rides after the first user and the second user and when the profile information of the third user satisfies the matching requirement set by the first user and the matching requirement set by the second user, the third user can ride with the first user and the second user.
